(19) United States
(12) Patent Application Publication
(10) Pub. No.: US 2025/0369559 A1
(43) Pub. Date: Dec. 4, 2025

(54) HARDWARE MOUNTING BRACKETS, ASSEMBLIES, AND SUBASSEMBLIES

(71) Applicant: LIBERTY HARDWARE MFG. CORP., Winston-Salem, NC (US)

(72) Inventors: Samuel DRIGGS, Winston-Salem, NC (US); John DUTTON, Winston-Salem, NC (US)

(21) Appl. No.: 19/220,346

(22) Filed: May 28, 2025

Related U.S. Application Data
(60) Provisional application No. 63/652,654, filed on May 28, 2024.

(51) Int. Cl. F16M 13/02; F16B 2/20

(52) U.S. Cl. CPC F16M 13/02; F16B 2/20

(57) ABSTRACT

A hardware mounting bracket is provided with a polymeric bracket body adapted to be mounted to a support surface, wherein an aperture is formed through a mounting surface of the bracket body. A rigid retainer is provided on one end of the bracket body to receive hardware supported thereon. A biasing retainer is provided on another end of the bracket body spaced apart from the rigid retainer, wherein the biasing retainer is formed integrally with the bracket body, and wherein the biasing retainer comprises a projection extending away from the bracket body. A hardware mounting bracket is provided with a bracket body with an inclined surface, and a slotted aperture is formed through the inclined surface. A hardware mounting bracket is provided with a bracket body. An angled ramp extends from the bracket body, wherein an aperture is formed through a mounting surface of the bracket body.

### CROSS-REFERENCE TO RELATED APPLICATIONS

This application claims the benefit of U.S. provisional application Ser. No. 63/652,654 filed May 28, 2024, the disclosure of which is hereby incorporated in its entirety by reference herein.

### TECHNICAL FIELD

Various embodiments relate to hardware mounting brackets, assemblies, and subassemblies.

### BACKGROUND

Austin, III et al., U.S. Pat. No. 9,839,332 B2 discloses Hardware Mounting Bracket, Assembly, and Hardware, and issued on Dec. 12, 2017, to Liberty Hardware Mfg. Corp.

### SUMMARY

According to an embodiment, a hardware mounting bracket is provided with a bracket body formed from a polymeric material and adapted to be mounted to a support surface, wherein an aperture is formed through a mounting surface of the bracket body. A rigid retainer is provided on one end of the bracket body to receive hardware supported thereon. A biasing retainer is provided on another end of the bracket body spaced apart from the rigid retainer, wherein the biasing retainer is formed integrally with the bracket body, and wherein the biasing retainer comprises a projection extending away from the bracket body.

According to a further embodiment, a contact pad is provided with an enlarged thickness formed laterally along a distal end of the biasing retainer.

According to another further embodiment, the biasing retainer is further provided with a leaf spring.

According to an even further embodiment, the biasing retainer is further provided with a first leaf spring portion extending away from the projection.

According to another even further embodiment, the projection is further defined as a first projection. The hardware mounting bracket is further provided with a second projection extending from the bracket body, along the first projection, and partially along the first leaf spring portion.

According to an even further embodiment, the second projection has a width narrower than the first projection.

According to another further embodiment, a third projection extends from the bracket body, along the first projection, and partially along the first leaf spring portion, wherein the third projection is spaced apart from the second projection with the first projection therebetween.

According to yet an even further embodiment, the third projection has a width narrower than the first projection.

According to another further embodiment, the first leaf spring portion extends away from the projection at an angle inclined away from the bracket body.

According to another further embodiment, the biasing retainer is further provided with a second leaf spring portion extending away from the first leaf spring portion.

According to an even further embodiment, the second leaf spring portion extends away from the first leaf spring portion at an angle declined away from the first leaf spring portion.

According to another even further embodiment, a contact pad is provided with an enlarged thickness formed laterally along a distal end of the second leaf spring portion.

According to another further embodiment, a structural insert is oriented at least partially in the bracket body and the rigid retainer.

According to an even further embodiment, the structural insert is further provided with a clip.

According to another further embodiment, the structural insert is formed from a dissimilar material than the polymeric bracket body.

According to another further embodiment, the structural insert is formed from steel.

According to another further embodiment, the polymeric bracket body and the rigid retainer are molded over the structural insert.

According to another further embodiment, the structural insert is further provided with a first plate extending at least partially along the bracket body. A second plate extends from the first plate at an angle to extend at least partially along the rigid retainer.

According to an even further embodiment, the structural insert is further provided with a pair of tabs extending from lateral sides of the second plate and angled toward the biasing retainer.

According to another embodiment, a hardware assembly is provided with a hardware mounting bracket with a bracket body formed from a polymeric material and adapted to be mounted to a support surface, wherein an aperture is formed through a mounting surface of the bracket body. A rigid retainer is provided on one end of the bracket body to receive hardware supported thereon. A biasing retainer is provided on another end of the bracket body spaced apart from the rigid retainer, wherein the biasing retainer is formed integrally with the bracket body, and wherein the biasing retainer comprises a projection extending away from the bracket body. Hardware is provided with a base, and a pair of recesses formed in the base, and sized to receive one of the rigid retainer and the biasing retainer of the hardware mounting bracket.

According to a further embodiment, no additional fasteners are provided to fasten the hardware to the hardware mounting bracket.

According to another further embodiment, the hardware recesses are symmetrical.

According to another embodiment, a hardware mounting bracket is provided with a bracket body adapted to be mounted to a support surface, wherein an inclined surface is formed in the bracket body, and wherein a slotted aperture is formed through the inclined surface.

According to yet another embodiment, a hardware mounting bracket is provided with a bracket body adapted to be mounted to a support surface. An angled ramp extends from the bracket body, wherein an aperture is formed through a mounting surface of the bracket body.

Another general embodiment provides a hardware mounting bracket that also includes a bracket body formed from a polymeric material and adapted to be mounted to a support surface, where an aperture is formed through a mounting surface of the bracket body. The bracket also includes a rigid retainer provided on one end of the bracket body to receive hardware supported thereon. The bracket also includes a biasing retainer provided on another end of the bracket body spaced apart from the rigid retainer, where the biasing retainer is formed integrally with the bracket body, and where the biasing retainer may include a projection extending away from the bracket body.

Various embodiments may include one or more of the following features. The hardware mounting bracket may include a contact pad with an enlarged thickness formed laterally along a distal end of the biasing retainer. The biasing retainer further may include a leaf spring. The biasing retainer further may include a first leaf spring portion extending away from the projection. The projection is further defined as a first projection; and where the hardware mounting bracket further may include a second projection extending from the bracket body, along the first projection, and partially along the first leaf spring portion. The second projection has a width narrower than the first projection. The third projection is spaced apart from the second projection with the first projection therebetween. The third projection has a width narrower than the first projection. The first leaf spring portion extends away from the projection at an angle inclined away from the bracket body. The biasing retainer further may include a second leaf spring portion extending away from the first leaf spring portion. The second leaf spring portion extends away from the first leaf spring portion at an angle declined away from the first leaf spring portion. The hardware mounting bracket may include a contact pad with an enlarged thickness formed laterally along a distal end of the second leaf spring portion. The hardware mounting bracket may include a structural insert oriented at least partially in the bracket body and the rigid retainer. The structural insert further may include a clip. The structural insert is formed from a dissimilar material than the polymeric bracket body. The structural insert is formed from steel. The polymeric bracket body and the rigid retainer are molded over the structural insert. The structural insert further may include: a first plate extending at least partially along the bracket body; and a second plate extending from the first plate at an angle to extend at least partially along the rigid retainer. The structural insert further may include a pair of tabs extending from lateral sides of the second plate and angled toward the biasing retainer. A hardware assembly may include: the hardware mounting bracket; and hardware with a base, and a pair of recesses formed in the base, and sized to receive one of the rigid retainer and the biasing retainer of the hardware mounting bracket. No additional fasteners are provided to fasten the hardware to the hardware mounting bracket. The hardware recesses are symmetrical.

Another general embodiment includes a hardware mounting bracket that may include a bracket body adapted to be mounted to a support surface.

Another general embodiment includes a hardware mounting bracket that may also include a bracket body adapted to be mounted to a support surface. The bracket also includes an angled ramp extending from the bracket body, where an aperture is formed through a mounting surface of the bracket body.

### BRIEF DESCRIPTION OF THE DRAWINGS

FIG. 1 is a side partial section view of a hardware assembly according to an embodiment;

FIG. 2 is a front perspective view of a mounting bracket of the hardware assembly of FIG. 1;

FIG. 3 is a partially exploded, side partial section view of the hardware assembly of FIG. 1, illustrating an assembly step;

FIG. 4 is another partially exploded, side partial section view of the hardware assembly of FIG. 1, illustrating another assembly step;

FIG. 5 is a side partial section view of a hardware assembly according to another embodiment;

FIG. 6 is a front perspective view of a mounting bracket of the hardware assembly of FIG. 5;

FIG. 7 is a partially exploded, side partial section view of the hardware assembly of FIG. 5, illustrating an assembly step;

FIG. 8 is a partially exploded, side partial section view of the hardware assembly of FIG. 5, illustrating another assembly step;

FIG. 9 is front perspective, partial section view of a hardware assembly according to another embodiment;

FIG. 10 is a front perspective view of a mounting bracket of the hardware assembly of FIG. 9;

FIG. 11 is a partially exploded, front perspective view of the hardware assembly of FIG. 9, illustrating an assembly step;

FIG. 12 is another partially exploded, front perspective view of the hardware assembly of FIG. 9, illustrating another assembly step;

FIG. 13 is a front perspective view of a mounting bracket of the hardware assembly of the hardware assembly of FIG. 5, according to an embodiment;

FIG. 14 is front elevation view of the mounting bracket of FIG. 13;

FIG. 15 is a right side elevation view of the mounting bracket of FIG. 13;

FIG. 16 is a rear elevation view of the mounting bracket of FIG. 13;

FIG. 17 is a left side elevation view of the mounting bracket of FIG. 13;

FIG. 18 is a top plan view of the mounting bracket of FIG. 13;

FIG. 19 is a bottom view of the mounting bracket of FIG. 13;

FIG. 20 is a section view taken along section line 20-20 in FIG. 13, according to an embodiment;

FIG. 21 is a section view taken along section line 20-20 in FIG. 13, according to another embodiment, illustrating the mounting bracket with a structural insert;

FIG. 22 is a right side elevation view of the structural insert of FIG. 21;

FIG. 23 is a front elevation view of the structural insert of FIG. 21;

FIG. 24 is a front perspective view of a mounting bracket of the hardware assembly of the hardware assembly of FIG. 5, according to an embodiment;

FIG. 25 is front elevation view of the mounting bracket of FIG. 24;

FIG. 26 is a right side elevation view of the mounting bracket of FIG. 24;

FIG. 27 is a rear elevation view of the mounting bracket of FIG. 24;

FIG. 28 is a left side elevation view of the mounting bracket of FIG. 24;

FIG. 29 is a top plan view of the mounting bracket of FIG. 24;

FIG. 30 is a bottom view of the mounting bracket of FIG. 24;

FIG. 31 is a front perspective view of a mounting bracket of the hardware assembly of the hardware assembly of FIG. 5, according to an embodiment;

FIG. 32 is front elevation view of the mounting bracket of FIG. 31;

FIG. 33 is a right side elevation view of the mounting bracket of FIG. 31;

FIG. 34 is a rear elevation view of the mounting bracket of FIG. 31;

FIG. 35 is a left side elevation view of the mounting bracket of FIG. 31;

FIG. 36 is a top plan view of the mounting bracket of FIG. 31; and

FIG. 37 is a bottom view of the mounting bracket of FIG. 31.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

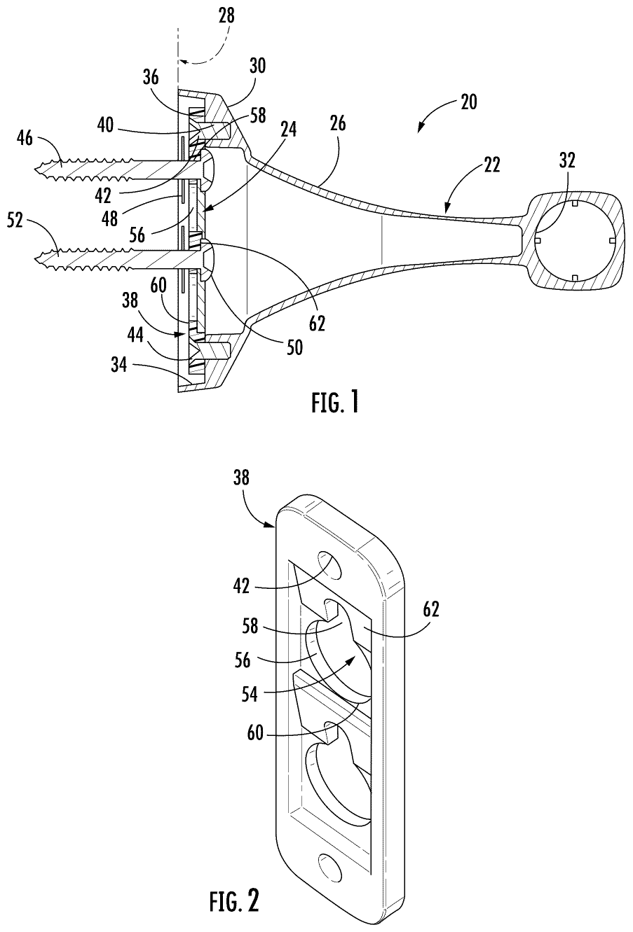

With reference to FIG. 1, a hardware assembly 20 is illustrated according to an embodiment. The hardware assembly 20 includes hardware 22 and a hardware mounting subassembly 24. The hardware 22 depicted includes a post 26 for supporting a bar, spaced apart from a support surface, such as an upright support surface or wall 28. Of course, various support surfaces are contemplated. The bar, not shown, may be a towel bar, a toilet paper holder bar, or the like.

The hardware 22 includes a base 30 to mount to the hardware mounting subassembly 24. The hardware 22 also includes a receptacle 32 to support the bar spaced apart from the base 30. Although the hardware 22 is illustrated and described for supporting a bar, the hardware 22 may be a hook for hanging a towel, a bathrobe, a clothing hanger or the like. Various domestic and commercial hardware is contemplated, such as towel rings, rope hooks, lighting, shelving, and the like.

Referring to FIGS. 1, 3, and 4, the base 30 has a cavity 34 formed therein for receiving and concealing the hardware mounting subassembly 24. Within the cavity 34, a mating surface 36 is provided to receive the hardware mounting subassembly 24. The hardware mounting subassembly 24 includes a mounting bracket 38 that is sized to be received against the mating surface 36 within the cavity 34.

The mounting bracket 38 is illustrated in greater detail in FIG. 2. The mounting bracket 38 has a body formed from a suitable polymeric material or the like, such as a nylon material, which may be structurally enhanced with carbon or glass fiber. Alternatively, the bracket 38 may be formed integrally with the base 30. Alternatively, the bracket 38 may be formed from a metallic alloy, such as a zinc alloy, for example.

Referring again to FIG. 1, the base 30 includes a plurality, such as a pair, of apertures 40, such as threaded apertures 40 formed into the mating surface 36. Likewise, the mounting bracket 38 includes a matching pair of through apertures 42 for alignment with the threaded apertures 40. A pair of threaded fasteners 44 are provided and received through the apertures 42 in the bracket 38, and threaded into the threaded aperture 40 of the base 30.

The hardware mounting subassembly 24 includes a plurality, such as a pair, of threaded screws 46, and a pair of washers 48. The threaded screws 46 attach directly to the wall 28. Although wood screws 46 are illustrated, nails, drywall anchors, concrete anchors, or the like, may be employed. The washers 48 provide a bearing surface between the screws 46 and the wall 28, if necessary. The screws 46 each include an enlarged screw head 50 and a threaded screw shank 52.

With reference to FIG. 2, the bracket 38 includes a pair of slotted apertures 54. The slotted apertures 54 include an enlarged region 56 that is oversized relative to the screw heads 50. The slotted apertures 54 each also include a narrower slot 58 that is oversized relative to the screw shank 52, but smaller than the screw head 50. The bracket 38 includes a reduced thickness in a pair of regions 60, each adjacent to the enlarged aperture region 56. The bracket 38 also includes a pair of ramped or inclined regions 62 with a tapered thickness adjacent the narrow slot 58 and widening away from the enlarged aperture region 56.

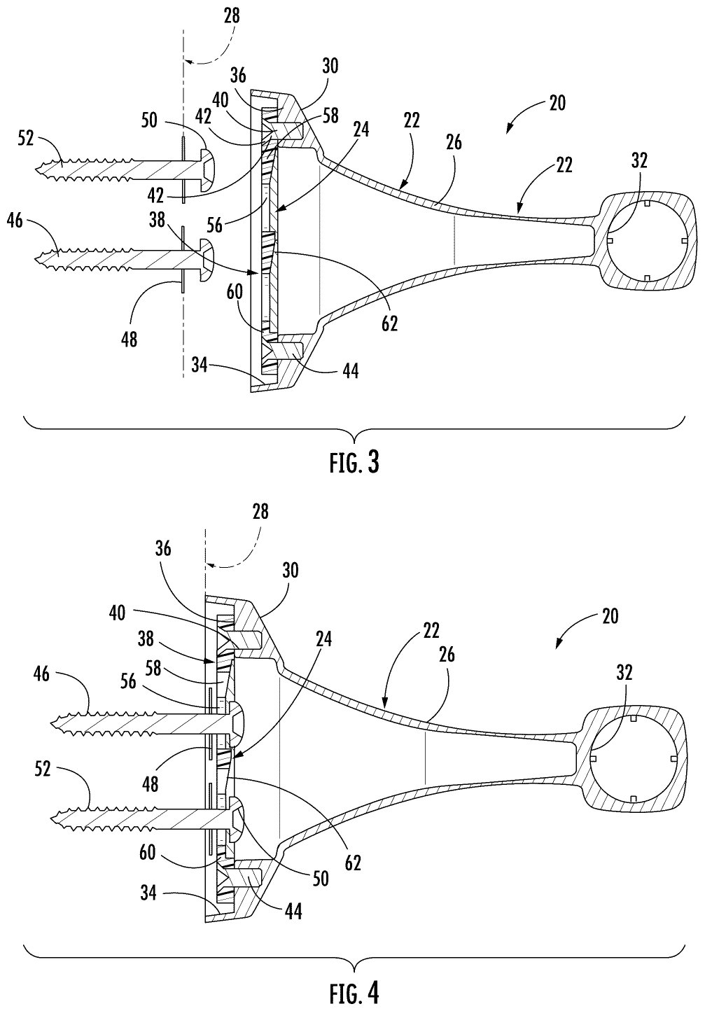

With reference to FIG. 3, the screws 46 are depicted as installed into the wall 28. The screw heads 50 are spaced away from the wall 28 to provide clearance between the screw heads 50 and the washers 48. In FIG. 3, the mounting bracket 38 is also fastened to the base 30 of the post 26 in an orientation such that the ramped regions 62 are facing into the cavity 34 of the base 30. The enlarged aperture regions 56 are aligned with the fastener heads 50, and the base is translated toward the wall 28 until the fastener heads 50 are received in the enlarged aperture regions 56 as illustrated in FIG. 4.

Next, the post 26 and base 30 are slid downward on the wall from FIG. 4 to FIG. 1, thereby assembling the hardware assembly 20 to the wall 28. As the mounting bracket 38 is slid relative to the fasteners 46, the screw heads 50 engage the ramped regions 62 and the screw shanks 52 are received within the narrow slots 58. The engagement of the screw heads 50 against the ramped regions 62 apply tension to the fasteners 46, thereby holding the base 30 firmly and securely against the wall 28. When fully flush against the wall 28, the post 26 is secured via friction and tension.

In order to remove the hardware 22, a user may slide the post 26 upward from the position in FIG. 1 to FIG. 4. Next, the user can translate the post from the position in FIG. 4 away from the wall 28 to the position in FIG. 3.

The hardware assembly 20 eliminates set screws through the base 30 (and any other additional hardware) thereby providing a uniform appearance, while reducing manufacturing and component costs. The hardware assembly 20 provides efficient and easy installation and removal from the wall 28 while providing adequate strength and support to pass standard weight load requirements. The design of the mounting bracket 38 also allows the hardware posts 26 to be symmetric, so there is no need to manufacture both left-facing and right-facing posts 26.

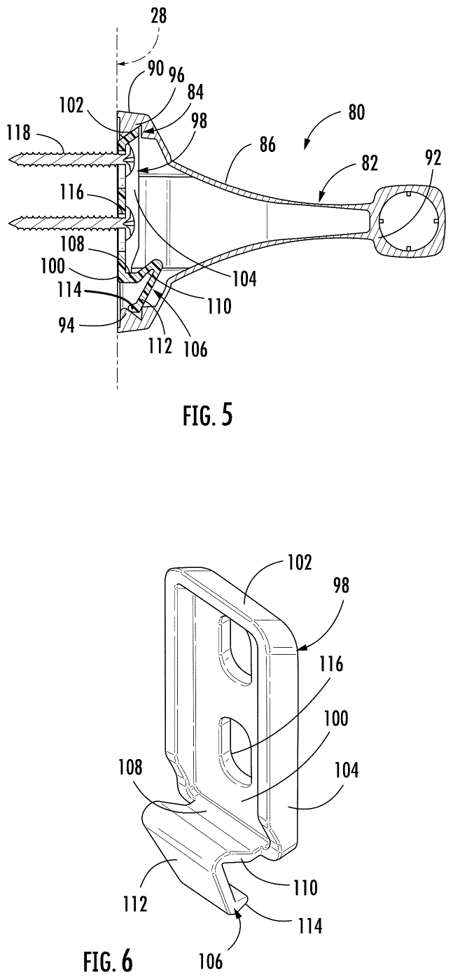

Referring now to FIG. 5, a hardware assembly 80 is illustrated according to another embodiment. The hardware assembly 80 includes hardware 82 and a hardware mounting subassembly 84. The hardware 82 depicted includes a post 86 for supporting a bar, spaced apart from a support surface, such as an upright support surface or wall 28. Of course, various support surfaces are contemplated. The bar, not shown, may be a towel bar, and toilet paper holder bar, or the like.

The hardware 82 includes a base 90 to mount to the hardware mounting subassembly 84. The hardware 82 also includes a receptacle 92 to support the bar spaced apart from the base 90. Although the hardware 82 is illustrated and described for supporting a bar, the hardware 82 may be a hook for hanging a towel, a bathrobe, a clothing hanger or the like. Various domestic and commercial hardware is contemplated, such as towel rings, rope hooks, lighting, shelving, and the like.

Referring to FIGS. 5, 7, and 8, the base 90 has a cavity 94 formed therein for receiving and concealing the hardware mounting subassembly 84. A pair of spaced apart recesses 96 are formed in the base 90 within the cavity 94. The recesses 96 are inclined away from the post 86 to provide inclined surfaces or ramps along the recesses 96.

The hardware mounting subassembly 84 includes a mounting bracket 98 with a body that is sized to be received against the mating recesses 96 within the cavity 94. The mounting bracket 98 is illustrated in greater detail in FIG. 6. The mounting bracket 98 is formed from a suitable polymeric material or the like, such as a nylon material, which may be structurally enhanced with carbon or glass fiber. Alternatively, the bracket 98 may be formed from a metallic alloy, such as a spring steel, for example.

As illustrated in FIG. 5, the mounting bracket 98 includes a base 100 as a substrate 100 to provide a mounting surface to mount directly to the wall 28. A retainer 102 extends from the base 100. The retainer 102 includes an inclined surface that narrows away from the base 100, and consequently, narrows away from the wall 28. A pair of sidewalls 104 also extend from the base 100 and connect to lateral ends of the retainer 102 to provide structural support to the retainer 102.

The mounting bracket 98 includes a biasing member 106, such as a leaf spring 106 extending from the base 100, spaced apart from the retainer 102. The retainer 102 and the leaf spring 106 may be provided on opposed ends of the base 100. The leaf spring 106 may be formed integrally with the mounting bracket 98. The leaf spring 106 includes a projection 108 to extend away from the base 100. The leaf spring 106 also includes a first portion 110 extending away from the projection 108 at an angle relative to the projection 108. The leaf spring 106 also includes a second portion 112 extending away from the first portion 110 at an angle relative to the first portion 110 for flexibility, compression, and elastic deformation of the leaf spring 106. A contact pad 114 is formed laterally along the leaf spring second portion 112.

The mounting bracket 98 includes a plurality, such as a pair, of apertures 116 formed through the bracket base 100. The apertures 116 may be slotted for adjustment and or alignment during installation. The hardware mounting subassembly 84 includes a plurality, such as a pair, of threaded screws 118. The threaded screws 118 attach the mounting bracket 98 directly to the wall 28. Although wood screws 118 are illustrated, nails, drywall anchors, concrete anchors, or the like, may be employed.

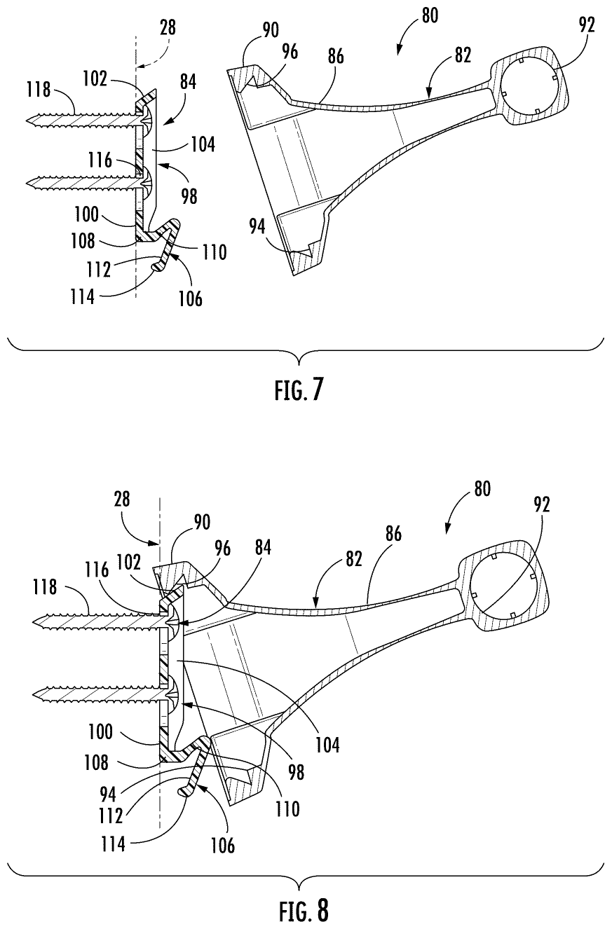

As illustrated in FIG. 7, after the mounting bracket 98 is installed to the wall 28, the hardware 82 is presented to the bracket 98 with the base 90 facing the bracket 98, and the base 90 angled away from the leaf spring 106. The hardware 82 is translated to the wall 28 from FIG. 7 to FIG. 8 so that the bracket retainer 102 engages a corresponding recess 96 in the base 90. Next, the hardware 82 is pivoted from the orientation in FIG. 8, to the orientation in FIG. 5 so that the leaf spring 106 elastically deforms and engages the other recess 96 with the contact pad 114 against the recess 96. Upon reaching the installed position of FIG. 5, the contact pad 114 may generate an audible noise, such as a snap or click, to inform the user that the hardware 82 is properly installed. The leaf spring 106 is compressed in the installed position in FIG. 5, thereby pressing the base 90 against the wall 28.

In order to remove the hardware 82, the user may slide the post 86 upward from the position in FIG. 5 to FIG. 8, and then rotate the recess 96 along the rigid retainer 102 to release the leaf spring 106. Next, the user can translate the post 86 from the position in FIG. 8 away from the wall 28 to the position in FIG. 7.

The hardware assembly 80 eliminates set screws (and any other additional hardware) through the base 90 thereby providing a uniform appearance, while reducing manufacturing and component costs. The hardware assembly 80 provides efficient and easy installation and removal from the wall 28 while providing adequate strength and support to pass standard weight load requirements. The design of the mounting bracket 98 also allows the hardware posts 86 to be symmetric, so there is no need to manufacture both left-facing and right-facing posts 86.

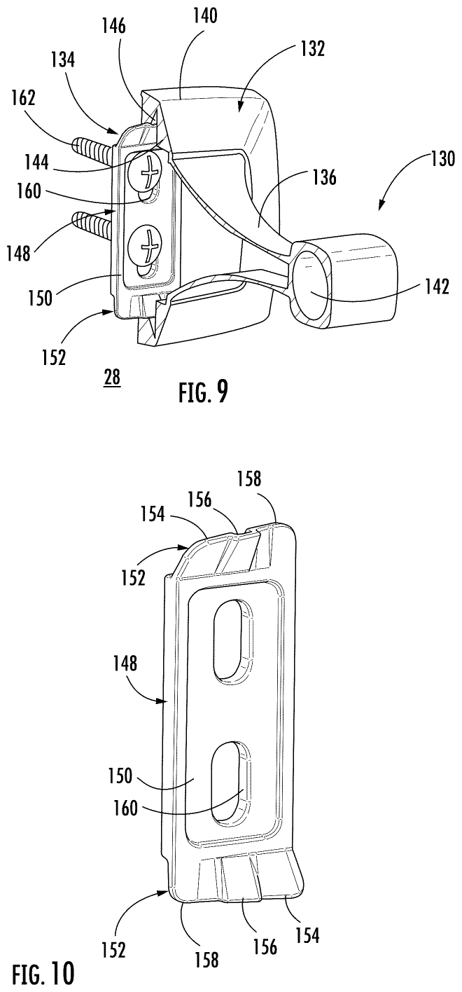

Referring now to FIG. 9, a hardware assembly 130 is illustrated according to an embodiment. The hardware assembly 130 includes hardware 132 and a hardware mounting subassembly 134. The hardware 132 depicted includes a post 136 for supporting a bar, spaced apart from a support surface, such as an upright support surface or wall 28. Of course, various support surfaces are contemplated. The bar, not shown, may be a towel bar, and toilet paper holder bar, or the like.

The hardware 132 includes a base 140 to mount to the hardware mounting subassembly 134. The hardware 132 also includes a receptacle 142 to support the bar spaced apart from the base 140. Although the hardware 132 is illustrated and described for supporting a bar, the hardware 132 may be a hook for hanging a towel, a bathrobe, a clothing hanger or the like. Various domestic and commercial hardware is contemplated, such as towel rings, rope hooks, lighting, shelving, and the like.

Referring to FIG. 9, the base 140 has a cavity 144 formed therein for receiving and concealing the hardware mounting subassembly 134. A pair of recesses 146 are formed in the base 140 within the cavity 144. The recesses 146 are inclined away from the post 136 to provide inclined surfaces or ramps along the recesses 146.

The hardware mounting subassembly 134 includes a mounting bracket 148 with a body that is sized to be received against the mating recesses 146 within the cavity 144. The mounting bracket 148 is illustrated in greater detail in FIG. 10. The mounting bracket 148 is formed from a suitable polymeric material or the like, such as a nylon material, which may be structurally enhanced with carbon or glass fiber. Alternatively, the bracket 148 may be formed from a metallic alloy, such as a spring steel, a zinc alloy, or other suitable examples.

The mounting bracket 148 includes a base 150 as a substrate to mount directly to the wall 28 as demonstrated in FIG. 9. A pair of ramped retainers 152 extend from the base 150 as wings 152. The retainers 152 each include an inclined surface that extends further away from the base 150 radially in a counterclockwise direction in FIG. 10. Each retainer 152 includes a first portion 154 that extends the furthest from the base 150 in the radially outward position. Next, and clockwise along each retainer 152, an intermediate portion 156 is provided. The intermediate portion 156 is less angled away from the base 150 than the first portion 154. The intermediate portions 156 may include a recess to provide a positive engagement position against the base recesses 146. Further clockwise along the retainers 152, third portions 158 are provided, which are less tapered than the first and intermediate retainer portions 154, 156. The retainers 152, each provided a pair of radially inclined, or helical, ramped surfaces for rotary locking engagement, to screw the base 140 onto the mounting bracket 148 by rotation of the base 140 to translate the base 140 axially toward the wall 28.

The mounting bracket 148 includes a plurality, such as a pair, of apertures 160 formed through the bracket base 150. The apertures 160 may be slotted for adjustment and or alignment during installation. Referring again to FIG. 9, the hardware mounting subassembly 134 includes a plurality, such as a pair, of threaded screws 162. The threaded screws 162 attach the mounting bracket 148 directly to the wall 28 as illustrated in FIGS. 9 and 11. Although wood screws 162 are illustrated, nails, drywall anchors, concrete anchors, or the like, may be employed.

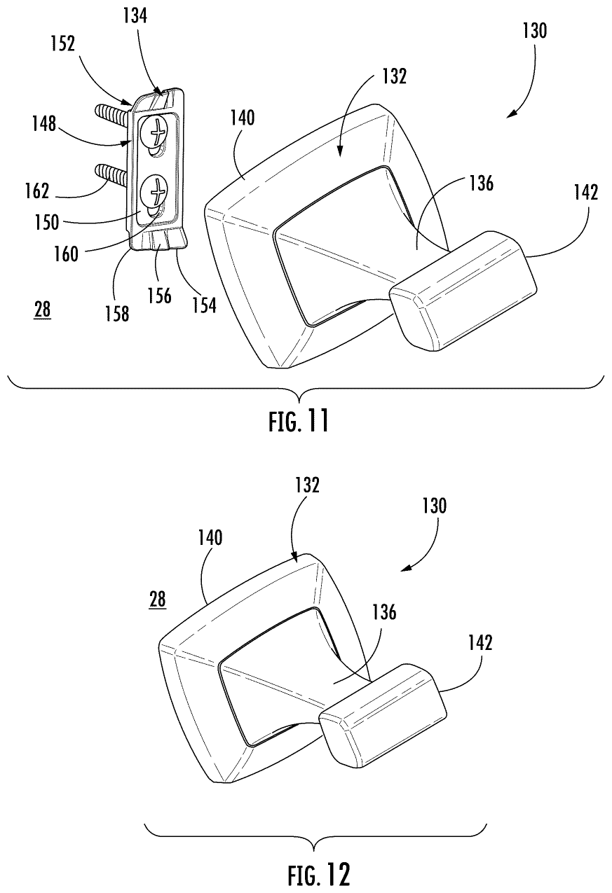

As illustrated in FIG. 11, after the mounting bracket 148 is installed to the wall 28, the hardware 132 is presented to the bracket 148 with the base 140 facing the bracket 148, and the base 140 rotated about the post about an eighth of a turn, for example. The hardware 132 is translated to the wall 28 from FIG. 11 to FIG. 12 so that the bracket retainer 152 is received within the cavity 144. The hardware 132 is then rotated clockwise about the post 136 so that the bracket retainers 152 engage the corresponding recesses 146 in the base 140. During this rotation, the recesses 146 engage the first portions 154, then pass to the intermediate portions 156 as illustrated in FIG. 9. The third portions 158 resist over rotation of the post 136, and the recessed intermediate portions 156 receive the recesses 146 of the base 140. The flexibility of the retainers 152 applies a force against the base 140 thereby securely pressing the base 140 into the wall 28.

In order to remove the hardware 132, the user may rotate the post 136 counterclockwise from the position in FIG. 9 to FIG. 12, and then translate the post 136 from the position in FIG. 12 away from the wall 28 to the position in FIG. 11.

The hardware assembly 130 eliminates set screws (and any other additional hardware) through the base 140 thereby providing a uniform appearance, while reducing manufacturing and component costs. The hardware assembly 130 provides efficient and easy installation and removal from the wall 28 while providing adequate strength and support to pass standard weight load requirements. The design of the mounting bracket 148 also allows the hardware posts 136 to be symmetric, so there is no need to manufacture both left-facing and right-facing posts 136.

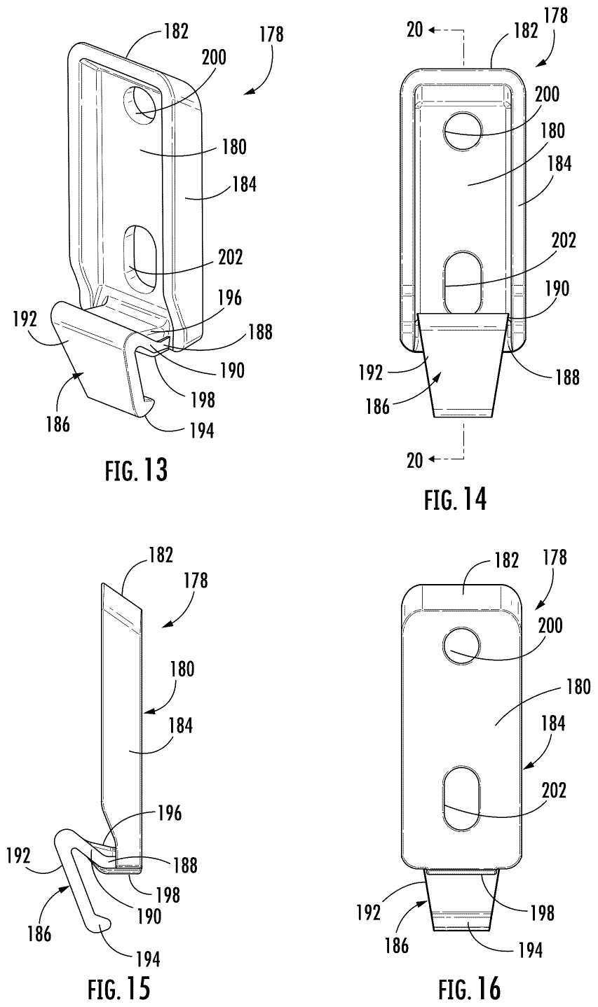

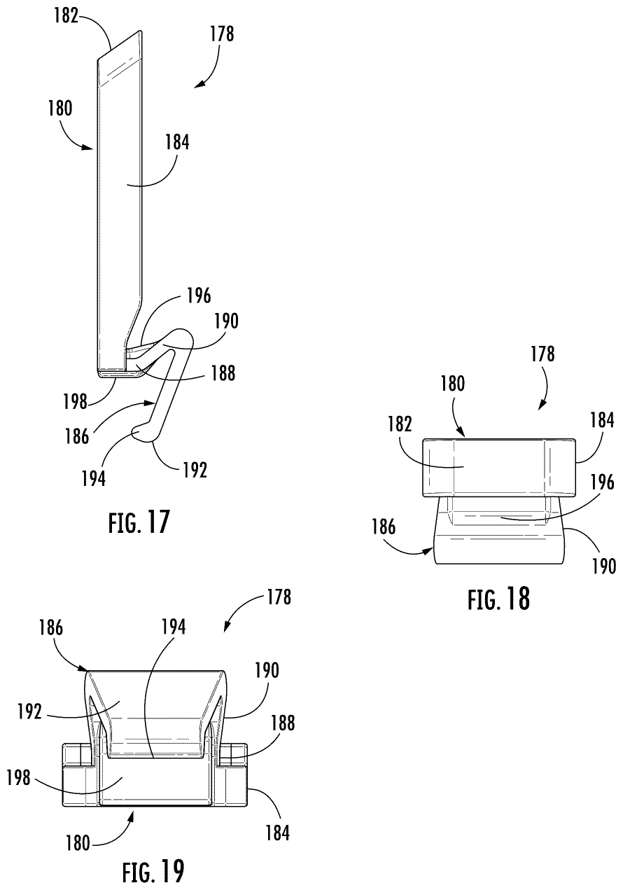

Referring now to FIGS. 13-20, a mounting bracket 178 is illustrated for utilization with the hardware mounting subassembly 84 of the embodiment of FIGS. 5-8. The mounting bracket 178 includes a body that is sized to be received against the mating recesses 96 within the cavity 94. The mounting bracket 178 is formed from a suitable polymeric material or the like, such as a nylon material, which may be structurally enhanced with carbon or glass fiber.

The mounting bracket 178 includes a base 180 as a substrate 180 to provide a mounting surface to mount directly to the wall 28. A retainer 182 extends from the base 180. The retainer 182 includes an inclined surface that narrows away from the base 180, and consequently, narrows away from the wall 28. A pair of sidewalls 184 also extend from the base 180 and connect to lateral ends of the retainer 182 to provide structural support to the retainer 182.

The mounting bracket 178 includes a biasing member 186, such as a leaf spring 186 extending from the base 180, spaced apart from the retainer 182. The retainer 182 and the leaf spring 186 may be provided on opposed ends of the base 180 to provide a flexible retainer 186, and an opposed, and relatively rigid, retainer 182. The leaf spring 186 may be formed integrally with the mounting bracket 178. The leaf spring 186 includes a first projection 188 to extend away from the base 180. The leaf spring 186 also includes a first portion 190 extending away from the first projection 188 at an angle relative to the first projection 188, which is inclined away from the bracket base 180. The leaf spring 186 also includes a second portion 192 extending away from the first portion 190 at an angle relative to the first portion 190 for flexibility, compression, and elastic deformation of the leaf spring 186. The angle of the second leaf spring portion 192 is declined away from the first leaf spring portion 190. A contact pad 194 is formed laterally along the leaf spring second portion 192. The contact pad 194 has a greater thickness than that of the leaf spring second portion 192.

The leaf spring 186 is designed to elastically deform during installation and disassembly. The leaf spring 186 is also designed to be partially deformed once installed to retain the hardware 82 upon the mounting bracket 178. In order to design deformation, and contrastingly, rigidity in regions of the leaf spring 186, the geometries and widths along the leaf spring 186 may vary according to an embodiment. For example, a second projection 196 is provided extending from the base 180, above and along the leaf spring first projection 188, and partially along the leaf spring first portion 190. The second projection 196 has a width that is narrower than that of the first projection 188. The second projection 196 adds structural rigidity to the projections 188, 196 of the leaf spring 186 to minimize elastic deformation in these regions to encourage the deformation at the leaf spring second portion 192 intersection with the leaf spring first portion 190.

Additionally, a third projection 198 is provided extending from the base 180, below and along the leaf spring first projection 188, and partially along the leaf spring first portion 190. The third projection 198 is spaced apart from the second projection 196 with the first projection 188 therebetween. The third projection 198 has a width that is narrower than that of the first projection 188. The third projection 198 adds structural rigidity to the projections 188, 196, 198 of the leaf spring 186 to minimize elastic deformation in these regions to encourage the deformation at the leaf spring second portion 192 intersection with the leaf spring first portion 190. The projections 188, 196, 198 cooperate to extend the leaf spring 186 cantilevered from the base 180.

The mounting bracket 178 includes a plurality, such as a pair, of apertures 200, 202 formed through the bracket base 180. The apertures 200, 202 may be round apertures, like the top aperture 200. The apertures 200, 202 may be slotted, such as the lower aperture 202, for adjustment and or alignment during installation. Referring again to FIGS. 5, 7, and 8, the hardware mounting subassembly 84 includes a plurality, such as a pair, of threaded screws 118. The threaded screws 118 attach the mounting bracket 178 directly to the wall 28. Although wood screws 118 are illustrated, nails, drywall anchors, concrete anchors, or the like, may be employed.

As illustrated in FIG. 7, and with reference to the embodiment of FIGS. 13-20, after the mounting bracket 178 is installed to the wall 28, the hardware 82 is presented to the bracket 178 with the base 90 facing the bracket 178, and the base 90 angled away from the leaf spring 186. The hardware 82 is translated to the wall 28 from FIG. 7 to FIG. 8 so that the bracket retainer 182 engages a corresponding recess 96 in the base 90. Next, the hardware 82 is pivoted from the orientation in FIG. 8, to the orientation in FIG. 5 so that the leaf spring 186 elastically deforms and engages the other recess 96 with the contact pad 194 against the recess 96. Upon reaching the installed position of FIG. 5, the contact pad 194 may generate an audible noise, such as a snap or click, to inform the user that the hardware 82 is properly installed. The leaf spring 186 is compressed in the installed position in FIG. 5, thereby pressing the base 90 against the wall 28.

In order to remove the hardware 82, the user may slide the post 86 upward from the position in FIG. 5 to FIG. 8, and then rotate the recess 96 along the rigid retainer 182 to release the leaf spring 186. Next, the user can translate the post 86 from the position in FIG. 8 away from the wall 28 to the position in FIG. 7.

The hardware assembly 80 eliminates set screws (and any other additional hardware) through the base 90 thereby providing a uniform appearance, while reducing manufacturing and component costs. The hardware assembly 80 provides efficient and easy installation and removal from the wall 28 while providing adequate strength and support to pass standard weight load requirements. The design of the mounting bracket 178 also allows the hardware posts 86 to be symmetric, so there is no need to manufacture both left-facing and right-facing posts 86.

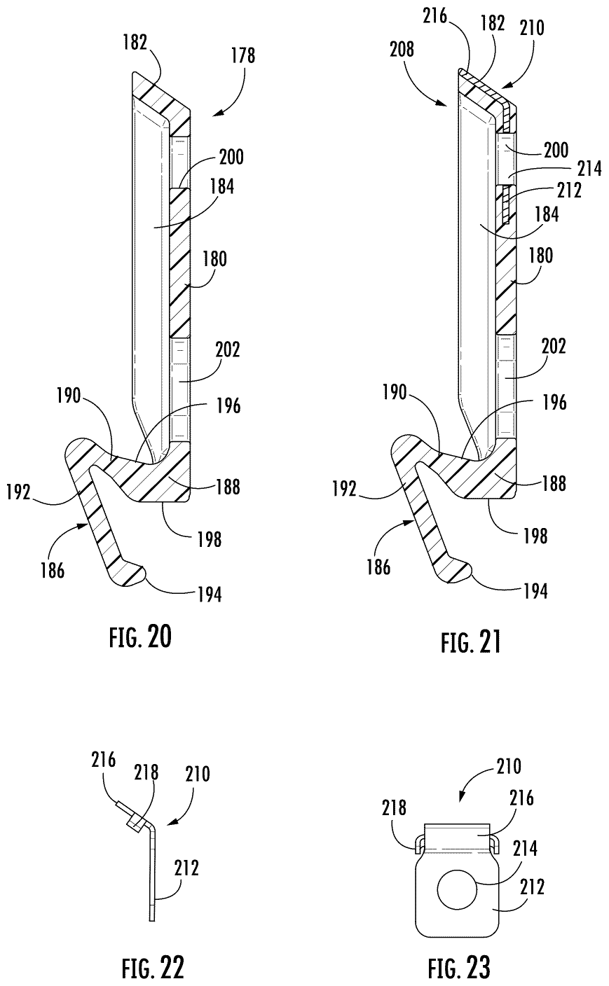

FIG. 20 illustrates a section view through the mounting bracket 178. This view illustrates that the mounting bracket 178 is formed integrally from a polymeric material. FIG. 21 illustrates a section view through the mounting bracket 178, according to another embodiment, which is assigned numeral 208. The mounting bracket 208 is designed to support hardware 82 of a greater load. The mounting bracket 208 includes a structural insert 210 to increase the structural integrity of the mounting bracket 208. The insert 210 is oriented at least partially within the base 180 and the rigid retainer 182.

The structural insert 210 is illustrated in further detail in FIGS. 22 and 23. Referring now to FIGS. 21-23, the structural insert 210 is provided as a clip 210. The clip 210 is formed from a stronger, dissimilar material than the polymeric bracket 208. For example, the clip 210 may be formed from a steel alloy. The clip 210 may be pre-formed, such as by a stamping operation. Subsequently, the clip 210 may be inserted into a mold, and the remainder of the mounting bracket 208 may be over-molded onto the clip 210.

The clip 210 includes a first plate 212. The first plate 212 is sized to extend at least partially within the base 180. The first plate 212 intersects the upper aperture 200 formed in the base 180. A corresponding aperture 214 is formed through the first plate 212 aligned with the upper aperture 200 to receive the fastener 118. A second plate 216 extends from the first plate 212 at an angle to extend at least partially along the rigid retainer 182. A pair of tabs 218 extend from lateral sides of the second plate 216 and are angled downward and toward the leaf spring 186. The tabs 218 provide additional structural support to the sidewalls 184 of the mounting bracket 208. The insert 210 cooperates with the mounting bracket 208 to distribute the load from the hardware 82 throughout the bracket 208 to minimize a stress point in the rigid retainer 182.

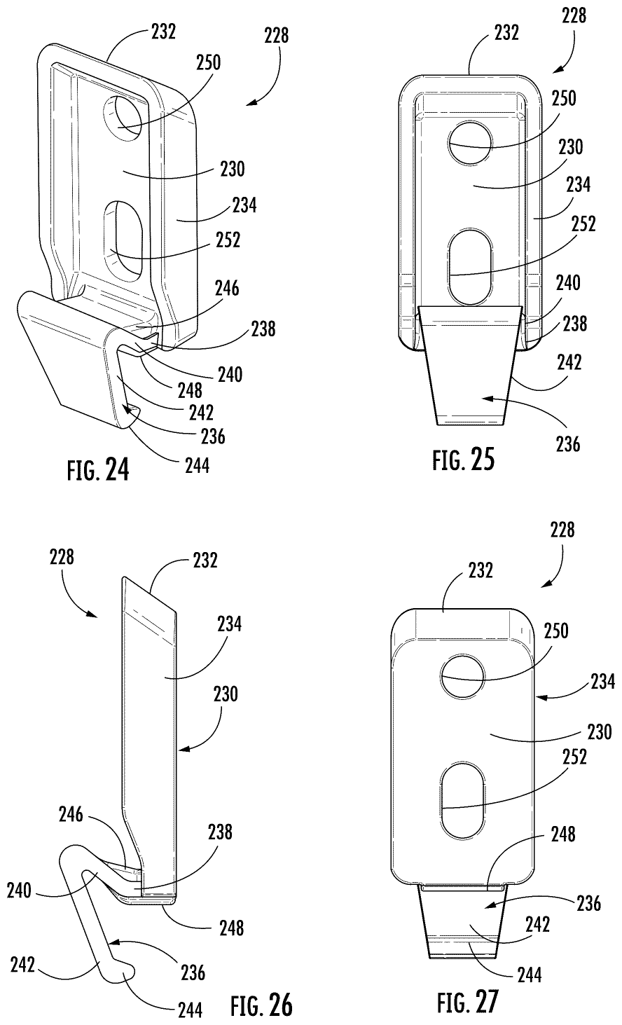

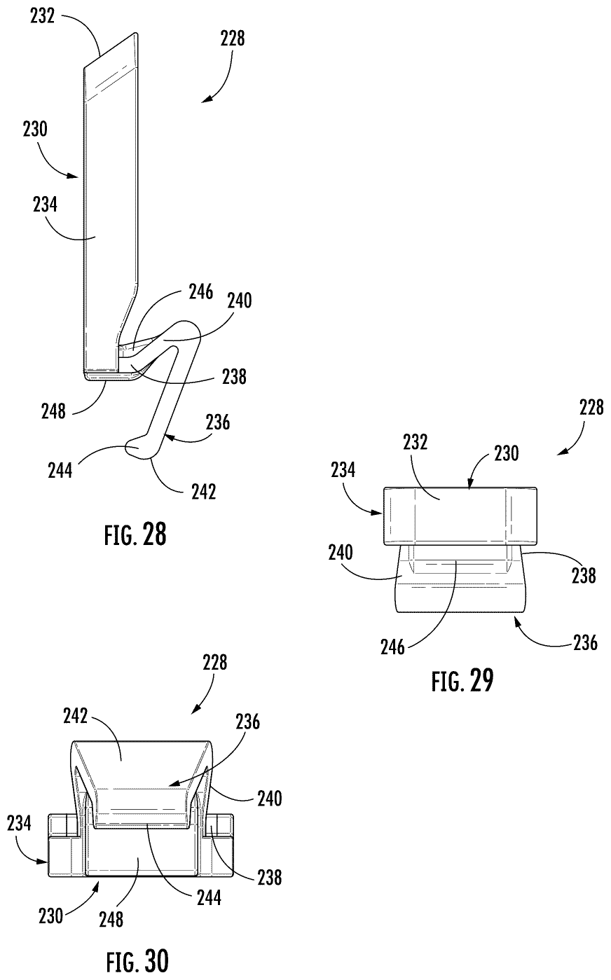

The mounting bracket 178 may be provided in various sizes, with or without the insert 210. FIGS. 24-30 illustrate a mounting bracket 228 according to another embodiment. The mounting bracket 228 is illustrated for utilization with the hardware mounting subassembly 84 of the embodiment of FIGS. 5-8. The mounting bracket 228 includes a body that is sized to be received against the mating recesses 96 within the cavity 94. The mounting bracket 228 is formed from a suitable polymeric material or the like, such as a nylon material, which may be structurally enhanced with carbon or glass fiber.

The mounting bracket 228 includes a base 230 as a substrate 230 to provide a mounting surface to mount directly to the wall 28. The substrate 230 has a shorter length in comparison to the base 180 of the prior embodiment. A retainer 232 extends from the base 230. The retainer 232 includes an inclined surface that narrows away from the base 230, and consequently, narrows away from the wall 28. A pair of sidewalls 234 also extend from the base 230 and connect to lateral ends of the retainer 232 to provide structural support to the retainer 232.

The mounting bracket 228 includes a biasing member 236, such as a leaf spring 236 extending from the base 230, spaced apart from the retainer 232. The retainer 232 and the leaf spring 236 may be provided on opposed ends of the base 230 to provide a flexible retainer 236, and an opposed, and relatively rigid, retainer 232. The leaf spring 236 may be formed integrally with the mounting bracket 228. The leaf spring 236 includes a first projection 238 to extend away from the base 230. The leaf spring 236 also includes a first portion 240 extending away from the first projection 238 at an angle relative to the first projection 238, which is inclined away from the bracket base 230. The leaf spring 236 also includes a second portion 242 extending away from the first portion 240 at an angle relative to the first portion 240 for flexibility, compression, and elastic deformation of the leaf spring 236. The angle of the second leaf spring portion 242 is declined away from the first leaf spring portion 240. A contact pad 244 is formed laterally along the leaf spring second portion 242. The contact pad 244 has a greater thickness than that of the leaf spring second portion 242.

The leaf spring 236 is designed to elastically deform during installation and disassembly. The leaf spring 236 is also designed to be partially deformed once installed to retain the hardware 82 upon the mounting bracket 228. In order to design deformation, and contrastingly, rigidity in regions of the leaf spring 236, the geometries and widths along the leaf spring 236 may vary according to an embodiment. For example, a second projection 246 is provided extending from the base 230, above and along the leaf spring first projection 238, and partially along the leaf spring first portion 240. The second projection 246 has a width that is narrower than that of the first projection 238. The second projection 246 adds structural rigidity to the projections 238, 246 of the leaf spring 236 to minimize elastic deformation in these regions to encourage the deformation at the leaf spring second portion 242 intersection with the leaf spring first portion 240.

Additionally, a third projection 248 is provided extending from the base 230, below and along the leaf spring first projection 238, and partially along the leaf spring first portion 240. The third projection 248 is spaced apart from the second projection 246 with the first projection 238 therebetween. The third projection 248 has a width that is narrower than that of the first projection 238. The third projection 248 adds structural rigidity to the projections 238, 246, 248 of the leaf spring 236 to minimize elastic deformation in these regions to encourage the deformation at the leaf spring second portion 242 intersection with the leaf spring first portion 240. The projections 238, 246, 248 cooperate to extend the leaf spring 236 cantilevered from the base 230.

The mounting bracket 228 includes a plurality, such as a pair, of apertures 250, 252 formed through the bracket base 230. The apertures 250, 252 may be round apertures, like the top aperture 250. The apertures 250, 252 may be slotted, such as the lower aperture 252, for adjustment and or alignment during installation. Referring again to FIGS. 5, 7, and 8, the hardware mounting subassembly 84 includes a plurality, such as a pair, of threaded screws 118. The threaded screws 118 attach the mounting bracket 228 directly to the wall 28. Although wood screws 118 are illustrated, nails, drywall anchors, concrete anchors, or the like, may be employed.

As illustrated in FIG. 7, and with reference to the embodiment of FIGS. 24-30, after the mounting bracket 228 is installed to the wall 28, the hardware 82 is presented to the bracket 228 with the base 90 facing the bracket 228, and the base 90 angled away from the leaf spring 236. The hardware 82 is translated to the wall 28 from FIG. 7 to FIG. 8 so that the bracket retainer 232 engages a corresponding recess 96 in the base 90. Next, the hardware 82 is pivoted from the orientation in FIG. 8, to the orientation in FIG. 5 so that the leaf spring 236 elastically deforms and engages the other recess 96 with the contact pad 244 against the recess 96. Upon reaching the installed position of FIG. 5, the contact pad 244 may generate an audible noise, such as a snap or click, to inform the user that the hardware 82 is properly installed. The leaf spring 236 is compressed in the installed position in FIG. 5, thereby pressing the base 90 against the wall 28.

In order to remove the hardware 82, the user may slide the post 86 upward from the position in FIG. 5 to FIG. 8, and then rotate the recess 96 along the rigid retainer 232 to release the leaf spring 236. Next, the user can translate the post 86 from the position in FIG. 8 away from the wall 28 to the position in FIG. 7.

The hardware assembly 80 eliminates set screws (and any other additional hardware) through the base 90 thereby providing a uniform appearance, while reducing manufacturing and component costs. The hardware assembly 80 provides efficient and easy installation and removal from the wall 28 while providing adequate strength and support to pass standard weight load requirements. The design of the mounting bracket 228 also allows the hardware posts 86 to be symmetric, so there is no need to manufacture both left-facing and right-facing posts 86.

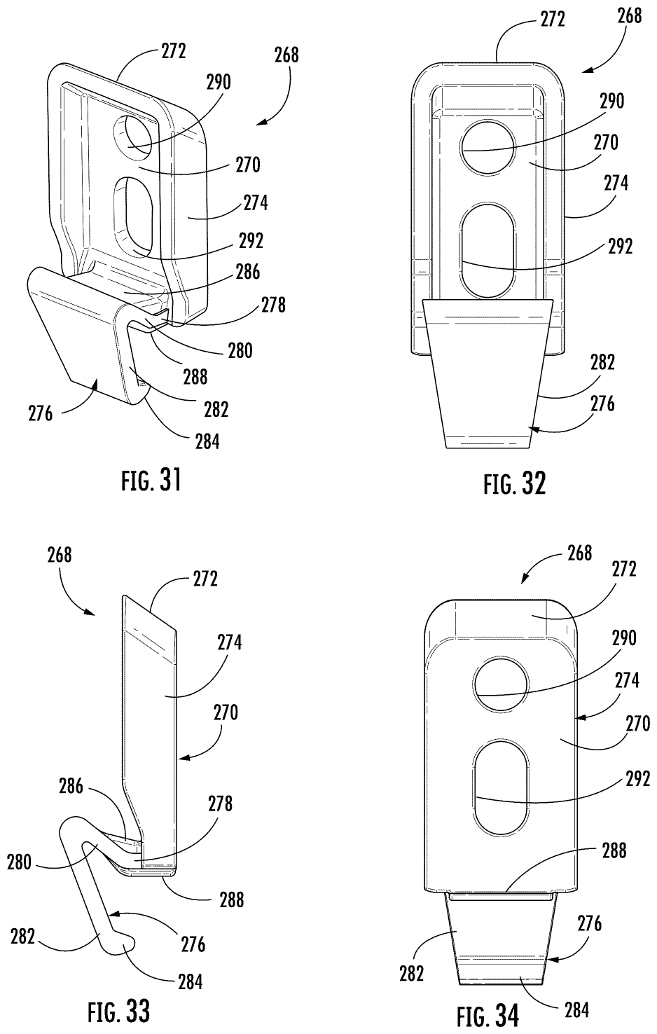

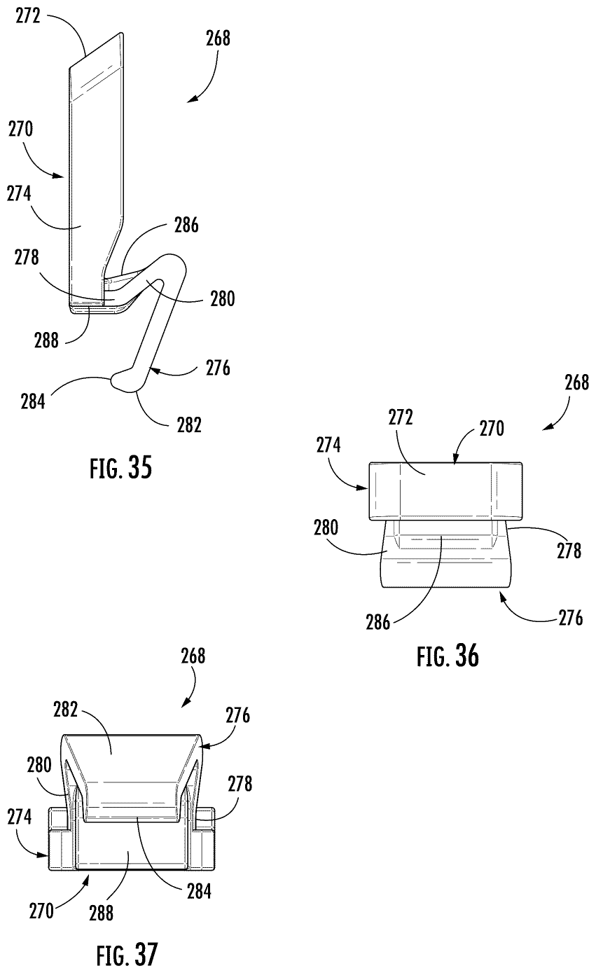

FIGS. 31-37 illustrate a mounting bracket 268 according to another embodiment. The mounting bracket 268 is illustrated for utilization with the hardware mounting subassembly 84 of the embodiment of FIGS. 5-8. The mounting bracket 268 includes a body that is sized to be received against the mating recesses 96 within the cavity 94. The mounting bracket 268 is formed from a suitable polymeric material or the like, such as a nylon material, which may be structurally enhanced with carbon or glass fiber.

The mounting bracket 268 includes a base 270 as a substrate 270 to provide a mounting surface to mount directly to the wall 28. The substrate 270 has a shorter length in comparison to the bases 180, 230 of the prior embodiments. A retainer 272 extends from the base 270. The retainer 272 includes an inclined surface that narrows away from the base 270, and consequently, narrows away from the wall 28. A pair of sidewalls 274 also extend from the base 270 and connect to lateral ends of the retainer 272 to provide structural support to the retainer 272.

The mounting bracket 268 includes a biasing member 276, such as a leaf spring 276 extending from the base 270, spaced apart from the retainer 272. The retainer 272 and the leaf spring 276 may be provided on opposed ends of the base 270 to provide a flexible retainer 276, and an opposed, and relatively rigid, retainer 272. The leaf spring 276 may be formed integrally with the mounting bracket 268. The leaf spring 276 includes a first projection 278 to extend away from the base 270. The leaf spring 276 also includes a first portion 280 extending away from the first projection 278 at an angle relative to the first projection 278, which is inclined away from the bracket base 270. The leaf spring 276 also includes a second portion 282 extending away from the first portion 280 at an angle relative to the first portion 280 for flexibility, compression, and elastic deformation of the leaf spring 276. The angle of the second leaf spring portion 282 is declined away from the first leaf spring portion 280. A contact pad 284 is formed laterally along the leaf spring second portion 282. The contact pad 284 has a greater thickness than that of the leaf spring second portion 282.

The leaf spring 276 is designed to elastically deform during installation and disassembly. The leaf spring 276 is also designed to be partially deformed once installed to retain the hardware 82 upon the mounting bracket 268. In order to design deformation, and contrastingly, rigidity in regions of the leaf spring 276, the geometries and widths along the leaf spring 276 may vary according to an embodiment. For example, a second projection 286 is provided extending from the base 270, above and along the leaf spring first projection 278, and partially along the leaf spring first portion 280. The second projection 286 has a width that is narrower than that of the first projection 278. The second projection 286 adds structural rigidity to the projections 278, 286 of the leaf spring 276 to minimize elastic deformation in these regions to encourage the deformation at the leaf spring second portion 282 intersection with the leaf spring first portion 280.

Additionally, a third projection 288 is provided extending from the base 270, below and along the leaf spring first projection 278, and partially along the leaf spring first portion 280. The third projection 288 is spaced apart from the second projection 286 with the first projection 278 therebetween. The third projection 288 has a width that is narrower than that of the first projection 278. The third projection 288 adds structural rigidity to the projections 278, 286, 288 of the leaf spring 276 to minimize elastic deformation in these regions to encourage the deformation at the leaf spring second portion 282 intersection with the leaf spring first portion 280. The projections 278, 286, 288 cooperate to extend the leaf spring 276 cantilevered from the base 270.

The mounting bracket 268 includes a plurality, such as a pair, of apertures 290, 292 formed through the bracket base 270. The apertures 290, 292 may be round apertures, like the top aperture 290. The apertures 290, 292 may be slotted, such as the lower aperture 292, for adjustment and or alignment during installation. Referring again to FIGS. 5, 7, and 8, the hardware mounting subassembly 84 includes a plurality, such as a pair, of threaded screws 118. The threaded screws 118 attach the mounting bracket 268 directly to the wall 28. Although wood screws 118 are illustrated, nails, drywall anchors, concrete anchors, or the like, may be employed.

As illustrated in FIG. 7, and with reference to the embodiment of FIGS. 31-37, after the mounting bracket 268 is installed to the wall 28, the hardware 82 is presented to the bracket 268 with the base 90 facing the bracket 268, and the base 90 angled away from the leaf spring 276. The hardware 82 is translated to the wall 28 from FIG. 7 to FIG. 8 so that the bracket retainer 272 engages a corresponding recess 96 in the base 90. Next, the hardware 82 is pivoted from the orientation in FIG. 8, to the orientation in FIG. 5 so that the leaf spring 276 elastically deforms and engages the other recess 96 with the contact pad 284 against the recess 96. Upon reaching the installed position of FIG. 5, the contact pad 284 may generate an audible noise, such as a snap or click, to inform the user that the hardware 82 is properly installed. The leaf spring 276 is compressed in the installed position in FIG. 5, thereby pressing the base 90 against the wall 28.

In order to remove the hardware 82, the user may slide the post 86 upward from the position in FIG. 5 to FIG. 8, and then rotate the recess 96 along the rigid retainer 272 to release the leaf spring 276. Next, the user can translate the post 86 from the position in FIG. 8 away from the wall 28 to the position in FIG. 7.

The hardware assembly 80 eliminates set screws (and any other additional hardware) through the base 90 thereby providing a uniform appearance, while reducing manufacturing and component costs. The hardware assembly 80 provides efficient and easy installation and removal from the wall 28 while providing adequate strength and support to pass standard weight load requirements. The design of the mounting bracket 268 also allows the hardware posts 86 to be symmetric, so there is no need to manufacture both left-facing and right-facing posts 86.

According to an embodiment, an overall ornamental appearance of the mounting bracket is illustrated in FIGS. 1-4. According to another embodiment, an overall ornamental appearance of the mounting bracket is illustrated in FIGS. 5-8. According to yet another embodiment, an overall ornamental appearance of the mounting bracket is illustrated in FIGS. 9-11. According to another embodiment, an overall ornamental appearance of the mounting bracket is illustrated in FIGS. 13-19. According to another embodiment, an overall ornamental appearance of the mounting bracket is illustrated in FIGS. 24-30. According to another embodiment, an overall ornamental appearance of the mounting bracket is illustrated in FIGS. 31-37.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A hardware mounting bracket comprising:
a bracket body formed from a polymeric material and adapted to be mounted to a support surface, wherein an aperture is formed through a mounting surface of the bracket body;
a rigid retainer provided on one end of the bracket body to receive hardware supported thereon; and
a biasing retainer provided on another end of the bracket body spaced apart from the rigid retainer, wherein the biasing retainer is formed integrally with the bracket body, and wherein the biasing retainer comprises a projection extending away from the bracket body.

2. The hardware mounting bracket of claim 1, further comprising a contact pad with an enlarged thickness formed laterally along a distal end of the biasing retainer.

3. The hardware mounting bracket of claim 1, wherein the biasing retainer further comprises a leaf spring.

4. The hardware mounting bracket of claim 3, wherein the biasing retainer further comprises a first leaf spring portion extending away from the projection.

5. The hardware mounting bracket of claim 4, wherein the projection is further defined as a first projection; and
wherein the hardware mounting bracket further comprises a second projection extending from the bracket body, along the first projection, and partially along the first leaf spring portion.

6. The hardware mounting bracket of claim 5, wherein the second projection has a width narrower than the first projection.

7. The hardware mounting bracket of claim 5, further comprising a third projection extending from the bracket body, along the first projection, and partially along the first leaf spring portion, wherein the third projection is spaced apart from the second projection with the first projection therebetween.

8. The hardware mounting bracket of claim 7, wherein the third projection has a width narrower than the first projection.

9. The hardware mounting bracket of claim 4, wherein the first leaf spring portion extends away from the projection at an angle inclined away from the bracket body.

10. The hardware mounting bracket of claim 4, wherein the biasing retainer further comprises a second leaf spring portion extending away from the first leaf spring portion.

11. The hardware mounting bracket of claim 10, wherein the second leaf spring portion extends away from the first leaf spring portion at an angle declined away from the first leaf spring portion.

12. The hardware mounting bracket of claim 11, further comprising a contact pad with an enlarged thickness formed laterally along a distal end of the second leaf spring portion.

13. The hardware mounting bracket of claim 1, further comprising a structural insert oriented at least partially in the bracket body and the rigid retainer.

14. The hardware mounting bracket of claim 13, wherein the structural insert further comprises a clip.

15. The hardware mounting bracket of claim 13, wherein the structural insert is formed from a dissimilar material than the polymeric bracket body.

16. The hardware mounting bracket of claim 13, wherein the structural insert is formed from steel.

17. The hardware mounting bracket of claim 13, wherein the polymeric bracket body and the rigid retainer are molded over the structural insert.

18. The hardware mounting bracket of claim 13, wherein the structural insert further comprises:
a first plate extending at least partially along the bracket body; and
a second plate extending from the first plate at an angle to extend at least partially along the rigid retainer.

19-22. (canceled)

23. A hardware mounting bracket comprising a bracket body adapted to be mounted to a support surface, wherein an inclined surface is formed in the bracket body, and wherein a slotted aperture is formed through the inclined surface.

24. A hardware mounting bracket comprising:
a bracket body adapted to be mounted to a support surface; and
an angled ramp extending from the bracket body, wherein an aperture is formed through a mounting surface of the bracket body.
